(19) United States
(12) Patent Application Publication
(10) Pub. No.: US 2015/0066160 A1
(43) Pub. Date: Mar. 5, 2015

(54) CONTROL PROGRAM MANAGEMENT DEVICE, INFORMATION PROCESSING DEVICE, AND CONTROL PROGRAM PROCESSING METHOD

(71) Applicant: Kabushiki Kaisha Toshiba, Tokyo (JP)

(72) Inventors: Junichi Kawamoto, Fuchu-shi (JP); Masahide Ono, Fuchu-shi (JP)

(21) Appl. No.: 14/310,813

(22) Filed: Jun. 20, 2014

(30) Foreign Application Priority Data
Aug. 30, 2013 (JP) 2013-180623

(51) Int. Cl. G05B 19/418

(52) U.S. Cl. CPC G05B 19/418
USPC 700/19; 700/87

(57) ABSTRACT

According to one embodiment, control program management device includes storage, transmitting unit, updating unit, and retaining unit. The transmitting unit transmits control program to first device. The updating unit updates, when the control program is transmitted to the first device, permission so as to prohibit second device from editing the control program. The retaining unit retains, based on information transmitted from the first device when the control program is transmitted to the first device, unique information identifying the first device and the control program. The transmitting unit further transmits, to the first device, inquiry of whether the first device is editing the control program. The retaining unit deletes the unique information when the first device is not editing the control program. The updating unit releases the permission so as to permit the second device from editing the control program when the first device is not editing the control program.

### CROSS-REFERENCE TO RELATED APPLICATIONS

This application is based upon and claims the benefit of priority from Japanese Patent Application No. 2013-180623, filed on Aug. 30, 2013, the entire contents of which are incorporated herein by reference.

### FIELD

Embodiments described herein relate generally to a control program management device, an information processing device, and a control program processing method.

### BACKGROUND

Conventionally, a plant control apparatus that generally controls a plant realizes automatic operation of the plant by executing an application program (hereinafter, referred to as a “control program”) and by performing controlling in accordance with procedures defined by the application program. A system programmer generates, tests, and coordinates the control program, and then provides the control program to a plant operator.

For secure control of the plant, the system programmer debugs the control program at the time of coordination. Here, the control program is written by the ladder diagram (LD) language, the function block diagram (FBD) language, the sequential function chart (SFC) language, and the structured text (ST) language, defined by the International Electrotechnical Commission (IEC) 61131-3 standard.

Normally, a plurality of system programmers perform operations on a single plant. Thus, a server and client environment is provided such that the system programmers can simultaneously perform operations and data backup. In such server and client environment, it is required to exclusively control the control program by using a database on the server and by collectively managing the control programs so that a number of people do not modify the same control program at the same time.

However, conventionally, even if a client is abnormally terminated, the control program and/or the database is remained exclusively controlled and/or the like. Accordingly, operations by other system programmers and/or the like are affected.

### BRIEF DESCRIPTION OF THE DRAWINGS

FIG. 1 is a diagram illustrating an example of a configuration of a server and clients that generate control programs for controlling plant, according to an embodiment;

FIG. 2 is a diagram illustrating an example of a block configuration realized by a server PC, in the embodiment;

FIG. 3 is a diagram illustrating an example of an edit screen displayed by an edit screen display control unit, in the embodiment;

FIG. 4 is a diagram illustrating an example of a block configuration realized by a client PC of the embodiment;

FIG. 5 is a diagram illustrating an example of a block configuration of a controller of the embodiment;

FIG. 6 is a flowchart illustrating a process of the client PC and the server PC of when abnormality occurred in the client PC, in the embodiment;

FIG. 7 is a flowchart illustrating an example of a process of the client PC and the server PC, and for deleting a temporary file indicating that the database is busy, in the embodiment;

FIG. 8 is a flowchart illustrating an example of a process of a failure diagnosis in the client PC, in the embodiment; and

FIG. 9 is a diagram illustrating an example of a dialog box displayed by the edit screen display control unit, the dialog box indicating that abnormality has occurred, in the embodiment.

### DETAILED DESCRIPTION

In general, according to one embodiment, a control program management device includes a storage unit, a transmitting unit, an updating unit, and a retaining unit. The storage unit stores therein a control program executable by a controller. A plant is controlled by the controller. The transmitting unit transmits the control program to a first information processing device. The control program is able to be edited by the first information processing device. The updating unit updates, when the control program is transmitted to the first information processing device, a permission so as to prohibit a second information processing device from editing the transmitted control program. The retaining unit retains, based on information transmitted from the first information processing device when the control program is transmitted to the first information processing device, unique information identifying the first information processing device and the transmitted control program. The transmitting unit further transmits, to the first information processing device identified by the unique information, an inquiry of whether the first information processing device is editing the control program identified by the unique information. The retaining unit further deletes the unique information when it is determined as a result of the inquiring by the transmitting unit that the first information processing device is not editing the control program. The updating unit further release the permission so as to permit the second information processing device from editing the control program transmitted to the first information processing device when it is determined as a result of the inquiring by the transmitting unit that the first information processing device is not editing the control program.

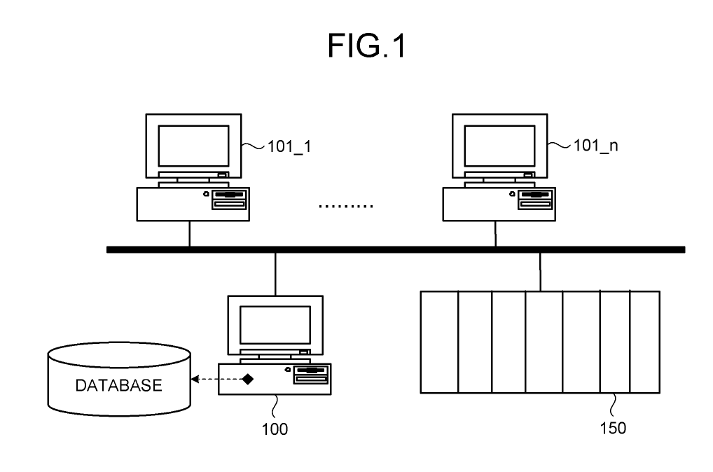

FIG. 1 is a diagram illustrating a configuration of a server and clients that generate control programs for controlling a plant, according to a present embodiment. According to an example illustrated in FIG. 1, the present embodiment generally has three configurations. In particular, the present embodiment is configured by a controller 150, client PCs 101_1 to 101_{—}n, and a server PC 100. The controller 150 and the client PCs 101_1 to 101_{—}n are connected to the server PC 100 via a communication network (e.g., Ethernet (registered trademark)).

The controller 150 is configured by a plurality of stations, and functions as a plant control device. Each of the stations constituting the controller 150 controls a plant (not illustrated) in accordance with control programs downloaded from the server PC 100. At the time of controlling, the controller 150 realizes a process control with respect to the plant by using advanced loop control and/or high-speed loop calculation process.

As the control program of the embodiment, for example, languages such as the ladder diagram (LD) language, the function block diagram (FBD) language, the sequential function chart (SFC) language, and the structured text (ST) language may be considered. These languages are in compliance with the International Electrotechnical Commission (IEC) 61131-3 standard, and defined as a programming language for the programmable logic controller (PLC). However, the languages are not limited to the above, and any program may be used as long as the program is able to control the plant.

The server PC 100 includes a database that stores therein control programs, and functions as a control program management apparatus that manages the control programs.

Each of the client PC 101_1 to 101_{—}n reads out the control program stored in the server PC 100, and edits the control program. Here, the present embodiment does not limit number of the connected client PC, and the number of the client PC can be any number as long as the number is greater than or equal to one.

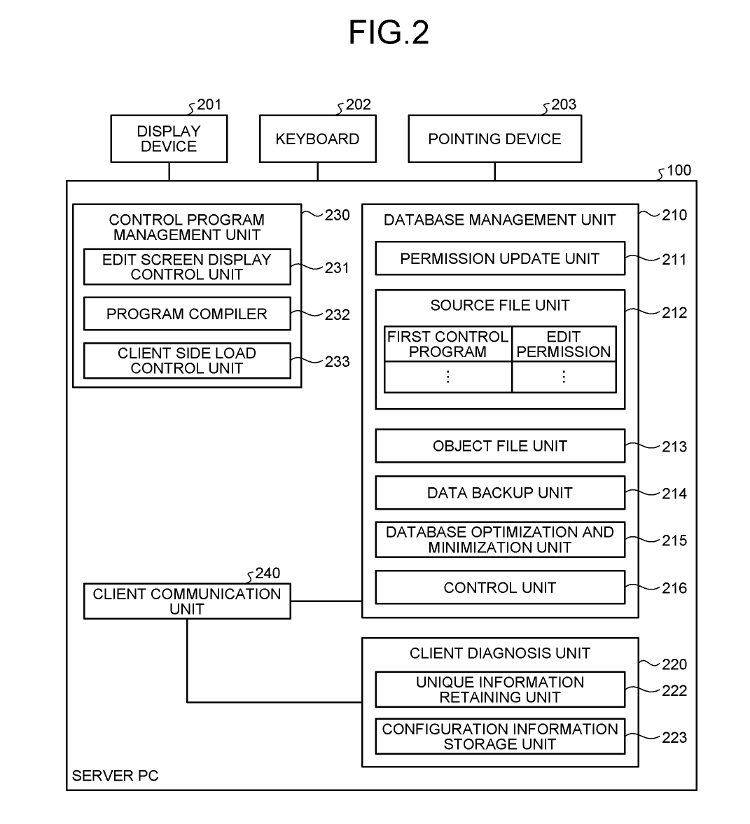

The server PC 100 executes a group of programs to realize various software configurations. FIG. 2 is a diagram illustrating an example of a block configuration realized in the server PC 100 of the present embodiment. As illustrated in FIG. 2, the server PC 100 is connected to a display device 201, a keyboard 202, and a pointing device 203.

Further, the server PC 100 includes a database management unit 210, a client diagnosis unit 220, a control program management unit 230, and a client communication unit 240.

The client communication unit 240 performs transmission and reception of data with respect to each of the client PCs 101_1 to 101_{—}n and the like.

The database management unit 210 includes a permission update unit 211, a source file unit 212, an object file unit 213, a data backup unit 214, a database optimization and minimization unit 215, and a control unit 216. The database management unit 210 of the present embodiment uses a database to manage source files (source file unit 212) of the control programs and object files (object file unit 213) obtained by compiling the source files.

The source file unit 212 retains therein source files of control programs executable by the controller 150. In the source file unit 212 of the present embodiment, each source file of the control program is stored in association with an edit permission. The edit permission is provided as a flag that indicates whether one of the server PC 100 and the client PCs 101_1 to 101_{—}n is editing the source file. When the edit permission indicates that editing of the source file is not in progress, the source file becomes editable. On the other hand, when the edit permission indicates that editing of the source file is in progress, editing of the source file becomes prohibited.

The object file unit 213 stores therein object files of the control programs directly executable by the controller 150. Here, the object files are obtained by compiling the source files retained in the source file unit 212.

The control unit 216 controls the entire database management unit 210. For example, in accordance with the control of the control unit 216, the client communication unit 240 performs transmission and reception of the source file of the control program with respect to one of the client PCs 101_1 to 101_{—}n which can edit the source file. Furthermore, when the client communication unit 240 receives the edited source file from one of the client PCs 101_1 to 101_{—}n, the control unit 216 updates the source file unit 212 by using the source file. Still further, when the object file obtained by compiling the source file is received from one of the client PCs 101_1 to 101_{—}n, the control unit 216 updates the object file unit 213 by using the object file.

Further, the control unit 216 performs control to pass the object file retained in the object file unit 213 to the controller 150.

When the client communication unit 240 transmits the source file of the control program to one of the client PCs 101_1 to 101_{—}n or when the source file is to be edited by the server PC 100, the permission update unit 211 updates the edit permission to “editing in progress” so that other client PCs 101_1 to 101_{—}n and the like cannot edit the source file of the control program.

Further, after the editing of the source file is finished and the source file unit 212 is updated by the edited source file, the permission update unit 211 updates the edit permission as “editing not in progress” so that other client PCs 101_1 to 101_{—}n can edit the source file.

Further, when abnormality or the like occurred in the client PCs 101_1 to 101_{—}n or the like that has been editing the source file and the editing of the source file by the client PCs 101_1 to 101_{—}n is stopped, the permission update unit 211 release the edit permission set as “editing in progress” and updates the edit permission by “editing not in progress” so that the source file which has been edited by one of the client PCs 101_1 to 101_{—}n can be edited by other client PCs 101_1 to 101_{—}n. Here, the client diagnosis unit 220 described later is used to determine that editing by the client PCs 101_1 to 101_{—}n is in progress.

The data backup unit 214 controls to take backup of the source files retained in the source file unit 212 and the object files retained in the object file unit 213. The backup destination is not limited particular ones, and any destination may be selected in accordance with embodiments.

The database optimization and minimization unit 215 optimizes and minimizes the database, which is configured by the source files retained in the source file unit 212 and the object files retained in the object file unit 213.

Further, according to the present embodiment, when accessing the source file unit 212 and/or the object file unit 213, the control unit 216 generates a temporary file indicating that the source file unit 212 and/or the object file unit 213 has been accessed. The temporary file is a file temporarily generated for access processing of when accessing the database.

Further, when access to the source file unit 212 and/or the object file unit 213 is finished (when a notification that access from the client PCs 101_1 to 101_{—}n is finished is received), the control unit 216 deletes the temporary file.

Here, upon taking backup or performing the optimization and the minimization, it is required to put the database (e.g., the source file unit 212 and the object file unit 213) in a state in which the database is not accessed by the client PCs 101_1 to 101_{—}n and/or the like. Therefore, upon taking backup or performing the optimization and the minimization, the client communication unit 240 transmits, by the control of the control unit 216 and in order to take backup and/or to perform the optimization and minimization of the database, a request to finish the access as well as a request to inform of the client PCs 101_1 to 101_{—}n that has currently been accessing, with respect to the client PCs 101_1 to 101_{—}n connected via a network.

The control program management unit 230 includes an edit screen display control unit 231, a program compiler 232, and a client side load control unit 233. The control program management unit 230 for example edits the control program. As described above, according to the present embodiment, a system programmer can edit the control program not only by the client PCs 101_1 to 101_{—}n but by the server PC 100, by referring to the edit screen.

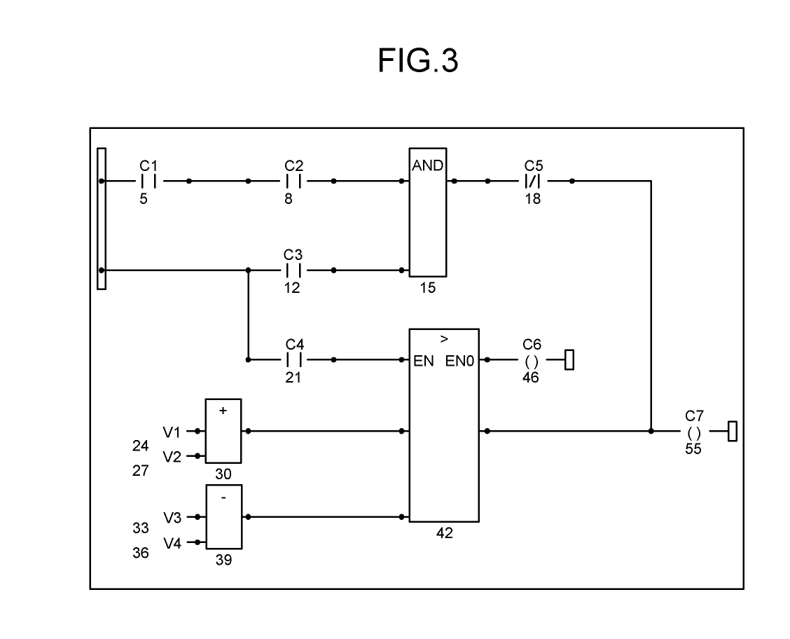

The edit screen display control unit 231 controls to display the edit screen of when the control program has been edited. FIG. 3 is a diagram illustrating an example of the edit screen to be displayed by the edit screen display control unit 231 of the present embodiment. FIG. 3 illustrates an example of an edit screen of the control program that uses LD or FBD language complying with the Japanese Industrial Standards (JIS) B3503 (or IEC 61131-3) standard.

When the control program is to be edited on the edit screen, the edit permission for the control program is obtained. That is to say, the edit permission of the control program is updated as “editing in progress” so as not to be edited by other client PCs. Then, when the editing is completed normally, the edit permission is released (i.e., the edit permission is updated as “editing not in progress”).

However, conventionally, when a control program is abnormally terminated due to failure of a client PC or a server PC having an edit permission that is set so that other client PC cannot edit the control program, the edit permission is maintained in a state in which other client PCs cannot edit the control program. Therefore, conventionally, other client PC or a server PC could not edit the same control program. In such a case, in order to recover an initial state, conventionally, it is required to reboot the server PC 100 and the client PCs 101_1 to 101_{—}n. In contrast, according to the present embodiment, the client diagnosis unit 220 monitors health of the connection with respect to the client PC so as to be able to appropriately perform recovery when failure occurs.

When a system programmer saves the control program, the control program is stored in the source file unit 212. Further, the program compiler 232 compiles the source file, and stores an object file generated via the compiling in the object file unit 213.

After the compiling is performed, the client side load control unit 233 transmits the object file to the controller 150. Consequently, the controller 150 becomes able to execute the edited control program.

The client diagnosis unit 220 includes a unique information retaining unit 222 and a configuration information storage unit 223. The client diagnosis unit 220 monitors the health of connection with respect to clients.

When the source file of the control program is transmitted to one of the client PCs 101_1 to 101_{—}n, the unique information retaining unit 222 retains therein unique information that identifies the transmitted source file and the one of the client PCs 101_1 to 101_{—}n of the transmission destination, based on the information transmitted from the one of the client PCs 101_1 to 101_{—}n.

The unique information retaining unit 222 of the present embodiment retains therein, as the unique information: login user names of the client PCs 101_1 to 101_{—}n with respect to the database; names of the client PCs 101_1 to 101_{—}n; user system names (names of systems that can specify plants); station names; slot numbers of the controllers; and control program names (programs, function blocks, functions in the IEC 61131-3).

That is to say, conventionally, when the client PC is abnormally terminated, recovery is difficult because the server PC could not be able to identify a client PC that had been editing the control program. In contrast, the server PC 100 of the present embodiment retains the unique information of the client PCs 101_1 to 101_{—}n that has been editing the control program. Consequently, when abnormal termination occurs in one of the client PCs 101_1 to 101_{—}n that has been editing the control program, it becomes capable to specify the one of the client PCs 101_1 to 101_{—}n that had been editing the control program.

In order for the client diagnosis unit 220 to monitor the health, the configuration information storage unit 223 retains a time interval for monitoring (inquiry) with respect to the client PCs 101_1 to 101_{—}n. In accordance with an operation received from a user, the client diagnosis unit 220 of the present embodiment sets the time interval. The configuration information storage unit 223 of the present embodiment stores the time interval for each of the client PCs 101_1 to 101_{—}n.

That is to say, the client diagnosis unit 220 of the present embodiment can adjusts the time interval (monitoring time) in accordance with a number of the client PCs connected according to plants and/or the load on the computer. That is to say, the number of client PCs or the load on the PCs vary among different plants, thereby it is required to be able to adjust the time interval (monitoring time). Therefore, there is provided the configuration information storage unit 223 that can adjust the time interval (monitoring time), in the present embodiment.

As a technique for the adjustment, the following can be considered. First, in an initial state, a default value is set for the time interval (monitoring time) set for each client PC.

Then, if the default value needs to be changed for different plants, the client diagnosis unit 220 changes the configuration information (e.g., text file) stored in the configuration information storage unit 223 in accordance with an operation of the system programmer. Consequently, the time interval (monitoring time) can be adjusted.

The time interval in the configuration information of the configuration information storage unit 223 can be set within a range between 30 seconds to 600 seconds (10 minutes). Here, the unit of time is not so particularly limited. However, the unit of time of seconds may be considered.

If the time interval is set to be less than or equal to 30 seconds in the configuration information, it is preferred to set the minimum time interval to 30 seconds so that the time interval does not become load for the monitoring.

Further, if the time interval is set to be larger than 600 seconds (10 minutes) in the configuration information, it is preferred to set the maximum time interval to 600 seconds (10 minutes).

In the configuration information, different configuration can be set for different server PCs and different client PCs. Consequently, it becomes possible to appropriately adjust the monitoring time in accordance with the number of client differing for different plants and the load of the PC.

Then, in accordance with a request from the client diagnosis unit 220, the client communication unit 240 transmits, with respect to the client PCs 101_1 to 101_{—}n identified by the unique information retained by the unique information retaining unit 222, an inquiry asking whether editing of a control program identified by the unique information is in progress.

That is to say, when the client PCs 101_1 to 101_{—}n and/or the like has been editing the control program, the server PC 100 of the present embodiment retains the unique information of the client PCs 101_1 to 101_{—}n. Then, the server PC 100 keeps retaining the unique information while the editing is in progress, and deletes the unique information when the editing is finished. However, if abnormality occurred in one of the client PCs 101_1 to 101_{—}n, the editing is terminated without the unique information being deleted. That is to say, when one of the client PCs 101_1 to 101_{—}n indicated by the unique information is not editing the control program while the unique information thereof is remained retained, it can be determined that abnormality has occurred in the one of the client PCs 101_1 to 101_{—}n.

As a process to be performed when it is determined that abnormality has occurred, the permission update unit 211 updates the edit permission of the source file of the control program indicated by the unique information as “editing not in progress”. Further, the client diagnosis unit 220 deletes the unique information. Here, the process is not limited to updating of the edit permission and the deleting of the unique information, and other process may be performed. Consequently, the abnormal state caused due to the abnormal termination of the client PCs 101_1 to 101_{—}n and/or the like is released.

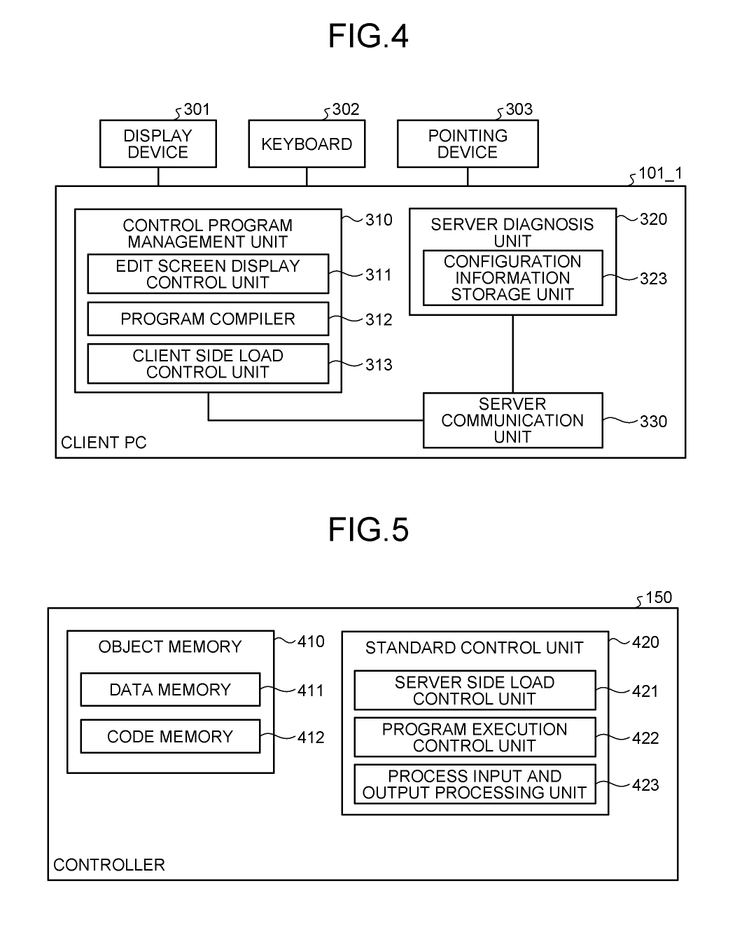

The client PC 101_1 realizes various software configurations by executing a group of programs. FIG. 4 is a diagram illustrating an example of a block configuration realized by the client PC 101_1 of the present embodiment. As illustrated in FIG. 4, the client PC 101_1 is connected to a display device 301, a keyboard 302, and a pointing device 303. Here, it is assumed that the client PCs 101_2 to 101_{—}n have the same configuration as that of the client PC 101_1, and the explanations thereof are omitted.

The client PC 101_1 further includes a control program management unit 310, a server diagnosis unit 320, and a server communication unit 330.

The server communication unit 330 transmits and receives data with respect to the server PC 100 and/or the like.

The control program management unit 310 includes an edit screen display control unit 311, a program compiler 312, and a client side load control unit 313. The control program management unit 310 edits the control program and/or the like. Here, a configuration of the control program management unit 310 is substantially the same as that of the control program management unit 230 of the server PC, thereby the explanations thereof are omitted. Thus, only the differences with respect to the server PC 100 are explained.

Upon launching the edit screen of the control program, the edit screen display control unit 311 controls the server communication unit 330 to transmit the unique information that identifies the client PC 101_1 and the control program, to the server PC 100. Consequently, it becomes possible for the server PC 100 to perform diagnosis on the client PC 101_1.

Further, the server communication unit 330 receives the source file of the control program from the server PC 100. Consequently, the edit screen display control unit 311 reads the received source file, and displays the edit screen.

The server diagnosis unit 320 includes a configuration information storage unit 323, and monitors the health of connection with respect to the server PC 100. In particular, when the client PC 101_1 is editing the source file of the control program, the server diagnosis unit 320 controls the server communication unit 330 to transmit, to the server PC 100, an inquiry of whether the unique information is retained.

Here, in the server PC 100 as described above, when it is determined that the abnormal termination and/or the like has occurred in the client PC 101_1 that has been editing the control program, the edit permission is updated and the unique information is deleted.

Therefore, the server diagnosis unit 320 controls the server communication unit 330 to monitor whether the server PC 100 continues to retain the unique information, thereby it can be recognized whether abnormality has occurred between the client PC 101_1 and the server PC 100.

As described above, when the control program is being edited by using the edit screen display control unit 311, the server diagnosis unit 320 controls the server communication unit 330 to transmit the inquiry of whether the server PC 100 has the unique information identifying the client PC 101_1 and the control program that is being edited by the client PC 101_1.

Then, when it is determined that the server PC 100 does not have the unique information as a result of the response from the server PC 100 responding to the inquiry, the server diagnosis unit 320 terminates the editing of the control program. Then, the edit screen display control unit 311 is notified that the communication with the server PC 100 is disconnected.

FIG. 5 is a diagram illustrating an example of a block configuration of the controller 150 of the present embodiment. The controller 150 is configured by an object memory 410 and a standard control unit 420.

The object memory 410 includes a data memory 411 and a code memory 412. The code memory 412 stores therein an object file of the control program. The data memory 411 is used as a work area for when the control program is executed, and stores therein parameters and/or the like.

The standard control unit 420 includes a server side load control unit 421, a program execution control unit 422, and a process input and output processing unit 423. The standard control unit 420 writes, reads, and executes the object file of the control program.

The server side load control unit 421 collaborates with the client side load control unit 233 of the client PCs 101_1 to 101_{—}n and the client side load control unit 313 of the server PC 100 to arrange the object program of the control program transmitted via the network to the code memory 412.

The program execution control unit 422 executes the control program stored in the object memory 410. The process input and output processing unit 423 receives the process signal from the plant, and send the received process signal to the control program. Consequently, the automatic control of the plant can be realized.

Next, a process performed between the client PC 101_1 and the controller 150 when the editing of the control program by the client PC 101_1 is terminated is explained.

When the editing by the client PC 101_1 is finished and the compiling and/or the like is finished, the source file and the object file of the control program is sent to the server PC 100. Consequently, the edited source file is saved in the source file unit 212, and the compiled object file is saved in the object file unit 213.

Then, the client side load control unit 313 of the client PC 101_1 takes the object file from the object file unit 213 of the server PC 100, and sends the object file to the server side load control unit 421 of the controller 150. Then, the server side load control unit 421 of the controller 150 arranges the sent object file on the code memory 412. Then, the program execution processing unit 422 executes the arranged object file, thereby the control program is executed.

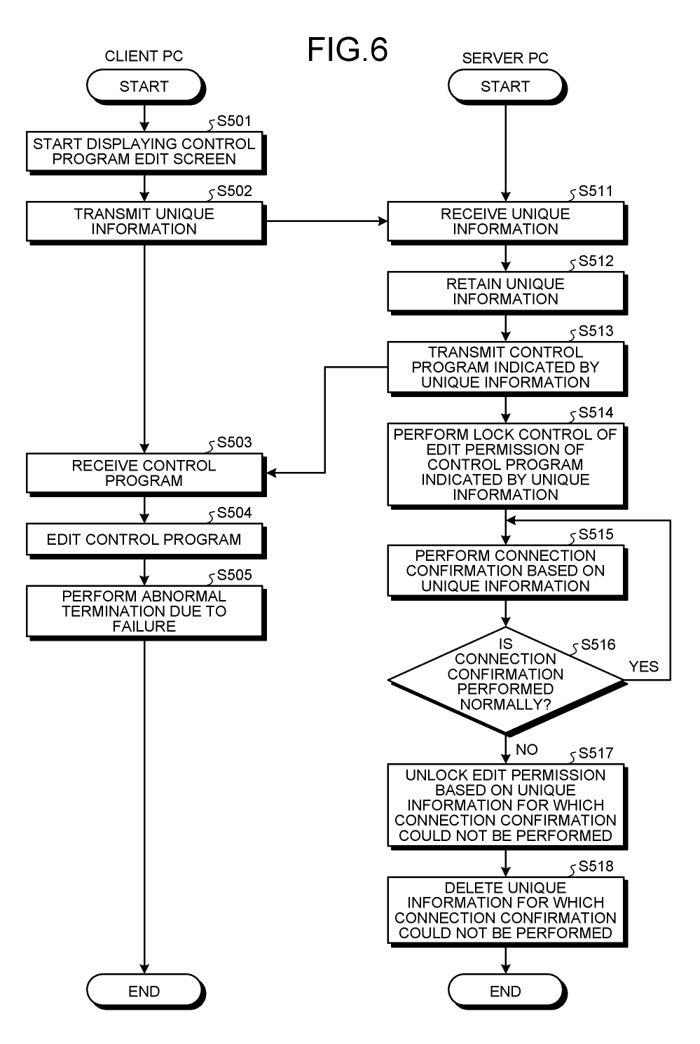

Next, process in the client PC 101_1 and the server PC 100 of the present embodiment is explained. In particular, process of when abnormality has occurred in the client PC 101_1 which has been editing the control program is explained. FIG. 6 is a flowchart illustrating an example of the above-mentioned processing in the client PC 101_1 and the server PC 100 of the present embodiment.

First, the edit screen display control unit 311 of the client PC 101_1 is activated, and displaying of the edit screen of the control program is started (S501).

Next, the server communication unit 330 of the client PC 101_1 transmits, to the server PC 100, unique information including information which identifies the client PC 101_1 and the control program to be edited (S502).

The client communication unit 240 of the server PC 100 receives the unique information from the client PC 101_1 (S511). Then, the unique information retaining unit 222 of the client diagnosis unit 220 retains the received unique information (S512).

Further, the client communication unit 240 transmits, to the client PC 101_1, the source file of the control program indicated by the received unique information (S513).

Then, the permission update unit 211 of the server PC 100 controls and locks the edit permission of the source file (associated with the source file of the transmitted control program) of the control program indicated by the unique information stored in the unique information retaining unit 222 so that other client PCs and/or the like cannot edit the source file (S514).

Next, the client diagnosis unit 220 of the server PC 100 performs connection confirmation with respect to the client PC 101_1 based on the unique information retained in the unique information retaining unit 222 (S515). In particular, the client diagnosis unit 220 asks the client PC 101_1 indicated by the unique information whether the client PC 101_1 has been editing the control program indicated by the unique information.

Then, based on the result of the inquiry, the client diagnosis unit 220 of the server PC 100 determines whether the connection confirmation has been performed normally (S516). If it is determined that the connection confirmation has been performed normally (if it is determined that a response indicating that the client PC is editing the control program is received) (YES at S516), the process from S515 is repeated in a periodic manner. Further, if the editing of the control program by the client PC is finished normally, the process is terminated.

The client PC 101_1 receives the source file of the control program from the server PC 100 (S503). Then, the edit screen display control unit 311 reads out and displays the received source file, and accepts editing of the control program by the user (S504). Subsequently, abnormality has occurred in the client PC 101_1, thereby the client PC 101_1 is terminated abnormally (S505). Consequently, editing of the control program is terminated, and in the server PC 100, the edit permission of the control program is maintained in the locked state.

Therefore, when the connection confirmation has not been performed normally based on the result of inquiry of S515 by the client diagnosis unit 220 (when a response indicating that the client PC has been editing the control program) (NO at S516), the permission update unit 211 unlocks the edit permission based on the unique information indicating the client PC 101_1 for which the connection confirmation could not be confirmed (S517). Furthermore, the unique information retaining unit 222 deletes the unique information indicating the client PC 101_1 for which the connection confirmation could not be confirmed (S518).

By the above mentioned process, it becomes possible to monitor the health of the control program that is being edited by the client PC and/or the like, and to appropriately and automatically update the client PCs and/or the like when abnormality has occurred.

Next, taking backup of the database and performing optimization and minimization of the database by the server PC 100 are explained. Taking backup and performing optimization and minimization of the database cannot be performed while there exists a temporary file generated when other information processing apparatus accesses the database. If an information processing terminal is terminated abnormally while accessing the database, there is a possibility that only the temporary file is left and taking backup and optimization and minimization of the database cannot be performed. Conventionally, in such a case, the server PC 100 and the client PCs 101_1 to 101_{—}n are rebooted. In contrast, according to the present embodiment, when a predetermined condition is satisfied, the temporary file is deleted.

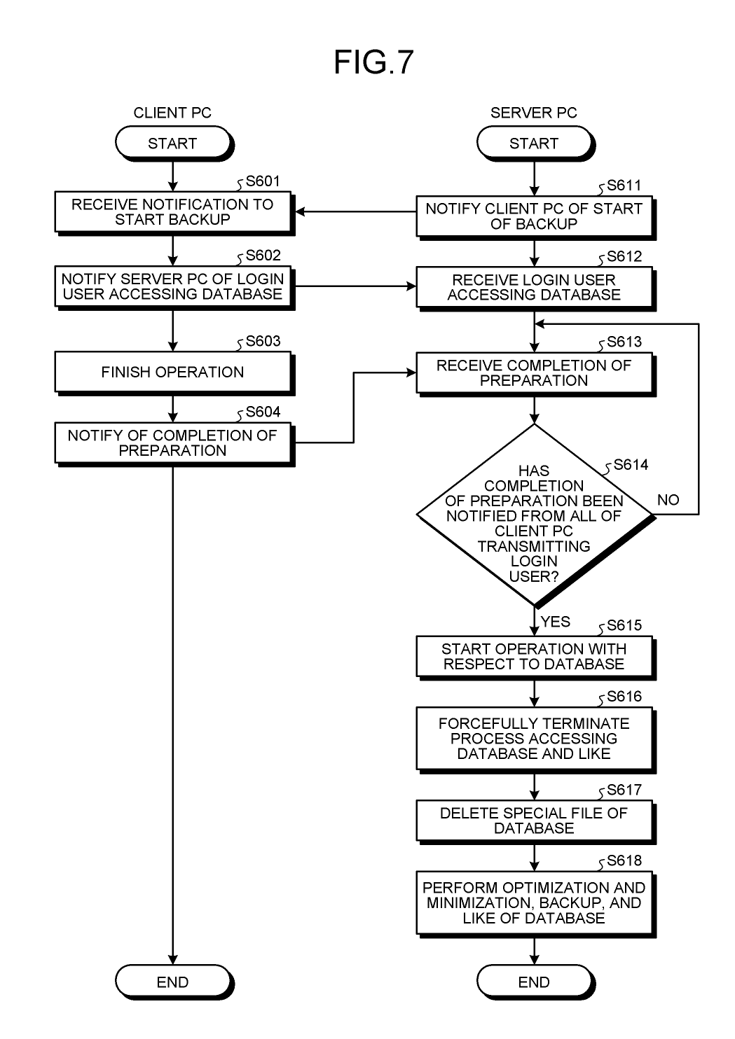

Deleting of the temporary file in the client PC 101_1 and the server PC 100 of the present embodiment is explained. Here, the temporary file indicates that the database has been accessed. FIG. 7 is a flowchart indicating an example of the above-mentioned process in the client PC 101_1 and the server PC 100 of the present embodiment.

First, when the data backup unit 214 or the database optimization and minimization unit 215 of the server PC 100 is to start the maintenance (e.g., backup, optimization, minimization), the client communication unit 240 notifies all of the client PCs 101_1 to 101_{—}n connected via the network that the maintenance is to be started, by broadcasting (S611).

Then, the server communication unit 330 of the client PC 101_1 receives a notification that the maintenance (e.g., backup) has been started (S601). Here, it is assumed that the client PC 101_1 is currently editing the control program.

In this case, the server communication unit 330 of the client PC 101_1 notifies the server PC 100 of the login user who has been accessing the database of the server PC 100 (S602). On the other hand, if the client PC 101_1 has not been editing the control program, the client PC 101_1 notifies the server PC 100 that preparation of the client PC 101_1 is finished.

On the other hand, the client communication unit 240 of the server PC 100 receives, from the client PC 101_1, the login user who has been accessing the database (the source file unit 212, the object file unit 213) (S612). Consequently, the server PC 100 performs controlling to wait for a certain period of time until the login user who has been accessing the database is logged out.

On the other hand, the edit screen display control unit 311 of the client PC 101_1 finishes displaying the edit screen of the source file, and the editing is terminated (S603). At this timing, the unique information is deleted, the edit permission is unlocked, and/or the like.

Then, the client PC 101_1 notifies the server PC 100 that the preparation is finished (all of the screens on which operation of the database access is performed are terminated) (S604). At this timing, the login user is notified to the server PC 100.

Then, the client communication unit 240 of the server PC 100 receives that the preparation is finished, from the client PC 101_1 (S613).

Next, the control unit 216 of the server PC 100 determines whether a notification indicating that the preparation is finished is received from all of the client PCs which have transmitted the login user (S614). If it is determined that the notifications have not been received (NO at S614), process begins from S613.

On the other hand, if the control unit 216 of the server PC 100 determines that the notification indicating that the preparation is finished is received from all of the client PCs (YES at S614), the data backup unit 214 begins an operation with respect to the database (the source file unit 212, the object file unit 213) (S615).

Here, if the client PC has been terminated abnormally and there remains a process accessing the database (the source file unit 212, the object file unit 213), the temporary file and/or the like cannot be deleted. Thus, because normal access to the database by all of the client PCs 101_1 to 101_{—}n should already be finished at 5616, the control unit 216 forcefully terminates the process and/or the like accessing the database as abnormal (S616).

Further, if there remains the temporary files, the control unit 216 deletes the temporary files (S617). Normally, a temporary file is deleted at the timing when the accessing to the database by all of the client PCs is finished. Therefore, the deleting at 5617 is performed only for the case when the client PC is abnormally terminated and/or the like.

Consequently, the data backup unit 214 performs a backup process with respect to the database (the source file unit 212, the object file unit 213) (S618).

By the above mentioned process, the special temporary file generated upon accessing is deleted, thereby backup can be performed. Here, the process illustrated in FIG. 7 is not limited to the backup process, and it can be any process as long as the process is for maintenance of the database, such as the optimization and minimization and/or the like of the database.

As is clear from the above mentioned result, according to the conventional technique, when a client PC is terminated abnormally due to various malfunction, the only way to recover the environment of the client PC and the server PC is to reboot the system.

On the other hand, according to the present embodiment, editing of the control program can be continued, and the temporary file generated due to the abnormal termination is deleted so as to be able to perform the optimization and minimization and the backup operation of the database. Consequently, an operation of a system programmer who is under operation in other client does not have to be stopped, thereby reduction of overall work efficiency can be prevented.

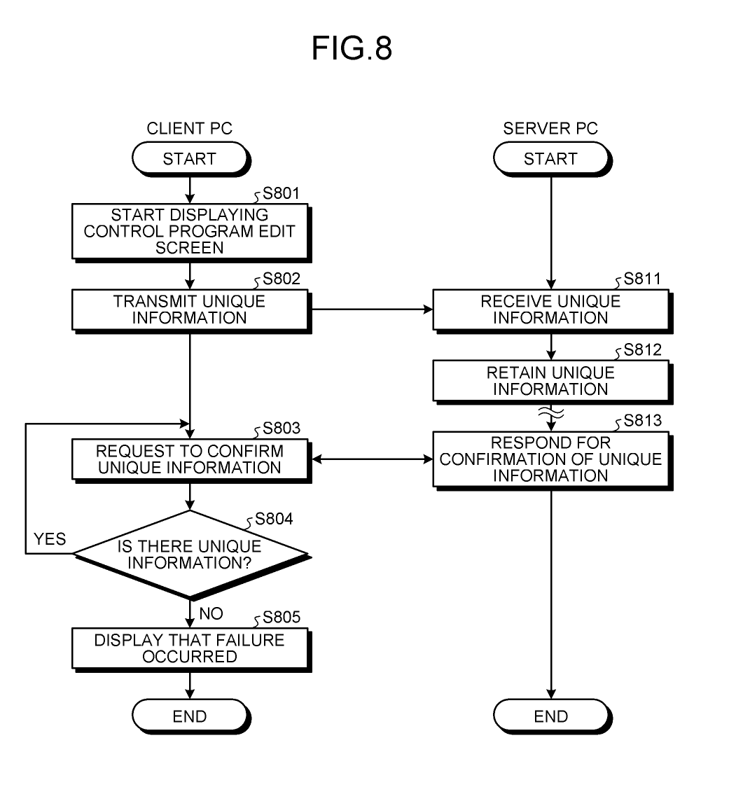

The diagnosis of whether there exists abnormality can be performed not only on the server PC 100 side, but can be performed on the client PCs 101_1 to 101_{—}n side. For example, the abnormality diagnosis can be performed on the client PCs 101_1 to 101_{—}n side so as to determine whether the server PC 100 has performed a process on the assumption that the client PC 101_1 is terminated abnormally, even if the client PC 101_1 has been editing the control program. Thus, the client PCs 101_1 to 101_{—}n determines whether abnormality has occurred in the communication with respect to the server PC 100 by recognizing whether the server PC 100 has deleted the unique information. FIG. 8 is a flowchart illustrating an example of a process of abnormality diagnosis by the client PC 101_1 of the present embodiment.

First, the edit screen display control unit 311 of the client PC 101_1 is activated, and begins displaying the edit screen of the control program (S801).

Then, the server communication unit 330 of the client PC 101_1 transmits, to the server PC 100, the unique information containing information that identifies the client PC 101_1 and the control program to be edited (S802).

The client communication unit 240 of the server PC 100 receives the unique information from the client PC 101_1 (S811). Then, the unique information retaining unit 222 of the client diagnosis unit 220 retains the received unique information (S812).

On the other hand, the server diagnosis unit 320 of the client PC 101_1 controls the server communication unit 330 to request for confirmation of the unique information transmitted at 5802 (S803). In response, the server PC 100 responds to the request for confirmation of the unique information (S813). Subsequently, the server diagnosis unit 320 determines whether there exists unique information in the result of response from the server PC 100 (S804). If it is determined that there exists the unique information (YES at S804), the process begins from S803 again.

Subsequently, by the process of FIG. 6, the server PC 100 cannot refer to the client PC 101_1 and the connection confirmation is not performed normally. Accordingly, the edit permission is unlocked and the unique information is deleted.

On the other hand, at 5804, if the server diagnosis unit 320 of the client PC 101_1 determines that there exists no unique information (NO at S804), the edit screen display control unit 311 displays that abnormality has occurred (S805). Further, the server diagnosis unit 320 terminates the editing of the source file of the control program performed in the control program management unit 310.

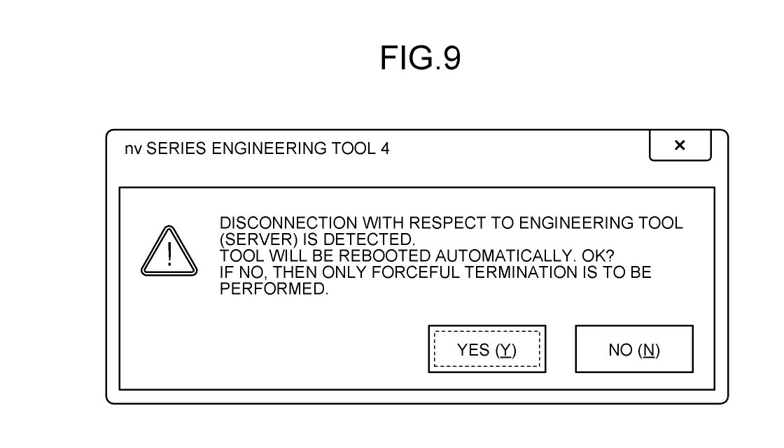

FIG. 9 is a diagram illustrating an example of a dialog box displayed by the edit screen display control unit 311 and indicating that abnormality has occurred. As illustrated in the example of FIG. 9, by displaying the dialog box, a system programmer can recognize that the communication with respect to the server PC 100 has been disconnected.

By the above-mentioned process, the client PC 101_1 can recognize whether abnormality has occurred in the communication with respect to the server PC 100. That is to say, conventionally, disconnection between the client PC and the server PC could not sometimes be immediately recognized when such a disconnection has occurred due to the network failure and/or the like while the client PC has been editing the control program without communicating with the server PC. In this case, a system programmer edits the control program without knowing about the disconnection. In this case, the source file that has been edited cannot be updated, thereby operation is wasted.

Thus, according to the present embodiment, the client PC 101_1 periodically communicate with the server PC 100. Then, if the communication cannot be established, it is determined that the network disconnection has occurred. In this case, the above mentioned message is displayed, and the client PC 101_1 is forcefully shut down and/or the like.

As described above, the disconnection between the client PCs and the server PC 100 can immediately be recognized on the client PCs 101_1 to 101_{—}n side even if the network failure has occurred. Consequently, the control program can be stopped from being further edited while the connection between the client PC and the server PC is disconnected, and wasting of the operations on the client PCs 101_1 to 101_{—}n side can be prevented.

In the environment of the server PC and the client PC of the present embodiment, management of the control program is unified in the database of the server PC, and the control program is exclusively controlled so that a number of people do not modify the same portion. Even when any one of the client PCs is abnormally terminated due to various failures while the control program has been exclusively controlled, the exclusive control can appropriately be released because the server PC 100 includes the above-mentioned configuration. Accordingly, it becomes capable to edit the control program by other client PCs.

Conventionally, when the client PC is abnormally terminated, the database becomes busy so that optimization and minimization and/or the backup operation of the database cannot be performed. In such a case, all of the system programmers need to stop their operations, and it is required to reactivate the server and client environment.

In contrast, the server PC 100 of the present embodiment includes the above mentioned configuration so that the busy state of the database is released. Accordingly, it becomes capable of executing the optimization and minimization and/or the backup operation without reactivating the server and client environment.

Conventionally, due to the network failure and/or the like, sometimes the disconnection with respect to the server PC cannot be recognized on the client PC side. In such a case, even if the client PC continues performing the operation, the operations are wasted since the result of operations cannot be reflected to the server PC. In contrast, according to the present embodiment, the abnormality diagnosis is performed, and when the abnormality has occurred, its occurrence is notified. Consequently, occurrence of unnecessary operations can be avoided.

Further, according to the server PC 100 of the above mentioned present embodiment, when the client PC is abnormally terminated, the abnormal termination is detected to unlock the edit permission and/or to delete the unique information. As a result, it becomes possible to perform appropriate recovery. Consequently, it is possible to prevent the influence on other system programmer and/or the like who is using the client PC and/or the like other than the client PC that is abnormally terminated.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control program management device comprising:
a storage unit that stores therein a control program executable by a controller, a plant being controlled by the controller;
a transmitting unit that transmits the control program to a first information processing device, the control program being able to be edited by the first information processing device;
an updating unit that updates, when the control program is transmitted to the first information processing device, a permission so as to prohibit a second information processing device from editing the transmitted control program; and
a retaining unit that retains, based on information transmitted from the first information processing device when the control program is transmitted to the first information processing device, unique information identifying the first information processing device and the transmitted control program, wherein
the transmitting unit further transmits, to the first information processing device identified by the unique information, an inquiry of whether the first information processing device is editing the control program identified by the unique information,
the retaining unit further deletes the unique information when it is determined as a result of the inquiring by the transmitting unit that the first information processing device is not editing the control program, and
the updating unit further release the permission so as to permit the second information processing device from editing the control program transmitted to the first information processing device when it is determined as a result of the inquiring by the transmitting unit that the first information processing device is not editing the control program.

2. The control program management device according to claim 1, further comprising a file control unit that generates, when the first information processing device accesses the storage unit, a temporary file indicating that the storage unit has been accessed, wherein,
upon performing maintenance of the storage unit, the transmitting unit further transmits a notification to the first information processing device connected to the network, the notification indicating that access to the storage unit is to be terminated, and
the file controller further deletes a process accessing the storage unit and the temporary file when a response indicating that access to the storage unit is terminated is received from the first information processing device to which the notification is transmitted.

3. The control program management device according to claim 1, further comprising a setup unit that sets a time interval for transmitting the inquiry by the transmitting unit, for each information processing device.

4. The control program management device according to claim 1, wherein, as the unique information, the retaining unit retains at least one of a login user name for when the first information processing device logs into the storage unit, a name of the first information processing device, a station name of the plant, a slot number of the controller of the plant, and a name of the control program.

5. The control program management device according to claim 1, wherein the storage unit is a database that retains a source file of the control program in association with the permission for the source file.

6. An information processing device comprising:
a receiving unit that receives a control program from a control program management device, the control program being managed by the control program management device and being executable by a controller, a plant being controlled by the controller;
a transmitting unit that transmits, to the control program management device, unique information identifying the information processing device and a control program edited by the information processing device, and transmits, while edit of the received control program is in progress, an inquiry of whether the control program management device has the unique information; and
a controlling unit that finishes editing the control program when it is determined as a result of the inquiry transmitted to the transmitting unit that the control program management device does not have the unique information.

7. The information processing device according to claim 6, further comprising a display control unit that displays, when it is determined as a result of the inquiry transmitted by the transmitting unit that the control program management device does not have the unique information, a notification that a communication between the control program management device and the information processing device is disconnected.

8. A control program processing method executed by a control program management device including a storage unit that stores therein a control program executable by a controller, a plant being controlled by the controller, the method comprising:
transmitting the control program to a first information processing device, the control program being able to be edited by the first information processing device;
updating, when the control program is transmitted to the first information processing device, a permission so as to prohibit a second information processing device from editing the transmitted control program;
retaining, based on information transmitted from the first information processing device when the control program is transmitted to the first information processing device, unique information identifying the first information processing device and the transmitted control program;
transmitting, to the first information processing device identified by the unique information, an inquiry of whether the first information processing device is editing the control program identified by the unique information;
deleting the unique information when it is determined as a result of the inquiring that the first information processing device is not editing the control program; and
releasing the permission so as to permit the second information processing device from editing the control program transmitted to the first information processing device when it is determined as a result of the inquiring that the first information processing device is not editing the control program.

9. The control program processing method according to claim 8, further comprising:
generating, when the first information processing device accesses the storage unit, a temporary file indicating that the storage unit has been accessed;
transmitting, upon performing maintenance of the storage unit, a notification to the first information processing device connected to the network, the notification indicating that access to the storage unit is to be terminated; and
deleting a process accessing the storage unit and the temporary file when a response indicating that access to the storage unit is terminated is received from the first information processing device to which the notification is transmitted.

10. The control program processing method according to claim 8, further comprising setting a time interval for transmitting the inquiry, for each information processing device.

11. The control program processing method according to claim 8, wherein, as the unique information, at least one of a login user name for when the first information processing device logs into the storage unit, a name of the first information processing device, a station name of the plant, a slot number of the controller of the plant, and a name of the control program, is retained.

12. A control program processing method executed by an information processing device, the method comprising:
receiving a control program from a control program management device, the control program being managed by the control program management device and being executable by a controller, a plant being controlled by the controller;
transmitting, to the control program management device, unique information identifying the information processing device and a control program edited by the information processing device, and transmits, while editing of the received control program is in progress, an inquiry of whether the control program management device has the unique information; and
finishing editing the control program when it is determined as a result of the inquiry transmitted to the transmitting unit that the control program management device does not have the unique information.

13. The control program processing method according to claim 12, further comprising displaying, when it is determined as a result of the inquiry that the control program management device does not have the unique information, a notification that a communication between the control program management device and the information processing device is disconnected.
